(19) United States
(12) Patent Application Publication
(10) Pub. No.: US 2012/0153612 A1
(43) Pub. Date: Jun. 21, 2012

(54) QUICK-RELEASE COUPLING FOR FLUID LINES

(75) Inventor: Stuart THOMSON, Preston (GB)

(73) Assignee: VERITAS AG, Gelnhausen (DE)

(21) Appl. No.: 13/328,409

(22) Filed: Dec. 16, 2011

(30) Foreign Application Priority Data
Dec. 17, 2010 (DE) 102010054896.0

(51) Int. Cl. F16L 35/00

(52) U.S. Cl. 285/81

(57) ABSTRACT

A quick-release coupling for fluid lines is disclosed which includes a connector with a connecting piece and at least one connecting pipe transversely projecting from the connecting piece, which connecting piece can be inserted into a receiving opening of a counterpart in a sealing manner and brought into locking engagement with the counterpart. To improve reliability and ease of mounting of a quick-release coupling, a force used to convert a securing device from an unlocking position to a locking position can be larger than a force used to bring the connecting piece into locking engagement with the counterpart.

The invention relates to a quick-release coupling for fluid lines, comprising: a connector with a connecting piece and at least one connecting pipe transversely projecting from said connecting piece, the connecting piece being of the type that can be inserted into a receiving opening of a counterpart in a sealing manner and brought into locking engagement with said counterpart by means of a locking or latching means; and a securing means that can be converted from a locking position in which the locking engagement is secured against unlocking to an unlocking position in which the locking engagement can be disengaged or released.

Such a quick-release coupling is known from WO 2007/042344 A1. When mounting said quick-release coupling, the connecting piece, on the one hand, has to be brought into locking engagement with said counterpart while, on the other hand, the securing means has to be converted from the unlocking position to the locking position. Occasionally, the connecting piece is not in full locking engagement with the counterpart, or the locking engagement releases unintentionally before the securing means is converted from the unlocking position to the locking position. Improper mounting of the quick-release couplings which are used, for instance, in vehicle leakage oil pipes implies considerable danger that the quick-release couplings might get disengaged under operation and, thus, fail to meet the coupling and sealing functions in a sufficient manner.

The invention is based on the object to improve reliability and ease of mounting of a quick-release coupling as mentioned above.

To solve the object basing the invention, a quick-release coupling for fluid pipes is provided, comprising: a connector with a connecting piece and at least one connecting pipe transversely projecting from said connecting piece, the connecting piece being of the type that can be inserted into a receiving opening of a counterpart in a sealing manner and brought into locking engagement with said counterpart by means of a locking means; and a securing means that can be converted from a locking position in which the locking engagement is secured against unlocking to an unlocking position in which the locking engagement can be disengaged, wherein a force used to convert the securing means from the unlocking position to the locking position (latching force) is larger than a force used to bring the connecting piece into locking engagement with the counterpart (insertion force). It may turn out to be useful to have the securing means being converted between locking position and unlocking position by being moved along the axis of the connecting piece. Preferably, the latching force and the insertion force are applied to the securing means in the insertion direction of the connecting piece, in order to optimally couple the latching movement of the securing means to the insertion movement of the connecting piece. As the latching force is larger than the insertion force, the connecting piece inevitably snaps into the counterpart while the securing means is being latched. Hence follows that the connecting piece and the counterpart inevitably are in locking engagement when the securing means is in the locking position. Accordingly, by locking or fixing the locking position of the securing means the locking engagement of the connecting piece with the counterpart can simultaneously be verified, thereby enhancing the process reliability while mounting the quick-release coupling and reducing the production costs, because the locking engagement does not have to be checked separately. According to the inventive solution, unintentional mounting errors can a priori be avoided owing to structural measures for error proofing (poka-yoke principle). Preferably, the connector substantially is X-, T-, Y- or L-shaped and preferably comprises two connecting pipes, the axes thereof lying in the same plane or in different planes with the axis of the connecting piece. The securing means preferably can be fixed to the connector in the locking position and/or unlocking position in a non-positive or force-fit and/or positive or form-fit, preferably in a latching manner. Optionally, an optically, haptically and/or acoustically sensible signal is generated when the securing means is being locked and/or unlocked. Preferably, the securing means embraces or encloses the connector in the locking position and/or in the unlocking position at least partially.

Any advantageous developments of the invention are subject-matters of the sub-claims.

It may turn out to be advantageous to have the securing means arranged, at least section-wise, on a side facing away from the connector in counter-insertion direction of the connecting piece. Thus, the securing means still can be easily mounted to the connector even when the connector has already been inserted.

It may be helpful to have the securing means being provided with an actuating element which is arranged on a side facing away from the connector in counter-insertion direction of the connecting piece. The securing means can, thus, be actuated or operated more easily.

It may turn out to be useful to have the actuating element being designed in a substantially annular shape. The term “annular” means that the actuating element or a section thereof extends along a self-contained line and is preferably formed in an annular, polygonal or other shape. The actuating element may, e.g. also be of mirror-symmetric of rotation-symmetric form and arranged concentrically to the axis of the connecting piece. Thus, forces acting on the actuating element can be evenly distributed so as to avoid that any moments of tilt or of torsion arise that might result in wedging the securing means with regard to the connector.

It may also be beneficial to have the actuating element being provided with at least one actuating surface facing away from the actuating element in counter-insertion direction of the connecting piece and/or at least one actuating surface facing away from the actuating element in the direction of insertion of the connecting piece. Owing to such measure, compressive forces can act on the operating surface(s) exactly in or against the direction of insertion of the connecting piece so as to avoid any moments of tilt or of torsion that might result in wedging the securing means with regard to the connector.

According to an advantageous development of the invention, the actuating element comprises an opening extending—preferably in counter-insertion direction of the connecting piece—in or through said actuating element. Such opening may, e.g. be used either as display means or for visual inspection in order to find out the position of the securing means with regard to the connector.

It may turn out to be advantageous to have at least a part of the connector being receivable in the actuating element opening. The actuating element can, thus, be positioned with particular accuracy with regard to the connector.

It may be useful to have at least a part of the connector, preferably said part of the connector that has been received in the opening, lining up precisely with at least one part of the actuating element in at least one position of the securing means, preferably in the locking position. Thus, it is particularly easy to find out the position of the securing means with regard to the connector by means of visual or haptic examination.

In another advantageous development of the invention, the securing means has an inner contour matching to the outer contour of a part of the connector so that the securing means is movably guided with regard to the connector between the unlocking and the locking position, preferably in a torsion-proof and/or tilt-proof manner. Incorrect handling of the securing means can, thus, largely be avoided.

It may be proven beneficial to have the securing means and/or the connector being provided with at least one snap-in protrusion, at least one guiding web and at least one snap-in reception arranged in said guiding web, the snap-in protrusion being conducted in a gliding manner between the locking position and the unlocking position in said guiding web, and the snap-in protrusion being catchable in said snap-in reception in the locking position and/or unlocking position. Thus, the securing means is positioned in the locking position and in the unlocking position but also in each intermediate position exactly with regard to the connector, the hazard of incorrect handling or operation thereby substantially being excluded.

It may be advantageous to have the securing means being provided with an actuating element secured to the connector by means of a securing element which is secured to the connector preferably in a detachable manner. According to one embodiment, the securing element is a lid or cover which can be connected to the connector by means of plug-in connection. According to another embodiment, the securing element or a portion thereof can be inserted into an opening of the connector, preferably into an opening of a fastening means. According to yet another embodiment, the securing element or a portion thereof can be attached to the connector, preferably to a fastening means and/or to at least one of said connecting pipes. To this end, the securing element may comprise one, two or more attachment portions. According to still another embodiment, the actuating element can be fixed to the securing element in at least one position, preferably in the unlocking position and/or in the locking position. According to still another embodiment, the securing element overlaps the actuating element on the rim-side and/or holds same to the connector in a captive manner. Further, it may be advantageous to have the securing element being of a longer form than the width of the actuating element.

A further aspect of the invention relates to a quick-release coupling for fluid pipes, comprising: a connector with a connecting piece and at least one connecting pipe transversely projecting from said connecting piece, the connecting piece being of the type that can be inserted into a receiving opening of a counterpart in a sealing manner and brought into locking engagement with said counterpart by means of a locking means; and a securing means that can be converted from a locking position in which the locking engagement is secured against unlocking to an unlocking position in which the locking engagement can be disengaged, wherein the locking means comprises at least one locking or latching arm, wherein the securing means and the locking arm have contours matching to each other so as to allow the securing means to be guided at said locking arm in a gliding manner between the unlocking position and the locking position in a torsion-proof or tilt-proof manner. Preferably, the inner contour of the securing means matches the outer contour of the locking arm, or vice versa. To this end, the securing means and the locking arm cooperate like female and male guide means. According to an embodiment, the contours of the securing means and of the locking arm match to each other in such a manner that the securing means can only be moved along an axis preferably extending parallel to the direction of insertion and/or parallel to the axis of the connector, while all other degrees of freedom of the securing means, particularly a movement transverse to said axis and/or a rotation about any axis, are blocked.

It may be useful to have the securing means being provided with at least two guide sections flanking a locking arm of the locking means on both sides and being guided at said locking arm in a gliding manner during the conversion between locking position and unlocking position. Thus, the securing means can be stabilized at the connecting piece or at the locking arm of the locking means in a tilt-free manner. This is particularly useful when large forces for converting the securing means from the unlocking position to the locking position have to be applied to the securing means. It can thus be ensured that the actuating surfaces of the securing means have been oriented optimally to receive the actuating forces and that the actuating forces exclusively act in/or against the direction of insertion of the connecting piece. According to one embodiment, the guide portions constitute a guide channel which receives the locking arm in a gliding manner during the conversion between the locking position and the unlocking position. During the conversion between the locking position and the unlocking position, the locking arm preferably moves deeper into the guide channel. According to another embodiment, a securing portion is provided between said two guide portions. In this concept, the two guide portions serve as stabilizing elements and are provided laterally adjacent to the securing portion, in order to position the securing portion firmly between the connecting piece and the locking arm and, thus, to block the locking arm. Said design has particularly been developed for automated connector mounting. According to yet another embodiment, the securing means comprises two guide portions for each locking arm of the locking means, said guide portions flanking said locking arm on both sides thereof and being guided to said locking arm in a gliding manner during the conversion between the locking position and the unlocking position.

The described embodiments can be combined arbitrarily. Preferred further developments of the invention can be obtained by combining the features disclosed in the claims, in the description and in the drawings.

### SHORT DESCRIPTION OF THE FIGURES

FIG. 1 is a perspective, partial section view of the quick-release coupling according to a first embodiment of the invention with a matching counterpart, with the securing means being in the unlocking position.

FIG. 2 is a perspective view of the quick-release coupling according to the first embodiment of the invention, with the securing means being in the locking position.

FIG. 3 is a plan view of the quick-release coupling according to the first embodiment of the invention in the unlocking position and in the locking position, wherein FIG. 3a shows a section along line A-A and FIG. 3b shows a section along line B-B.

FIG. 4 is a perspective view of the quick-release coupling according to the first embodiment of the invention in locking engagement with the matching counterpart, with the securing means being in the unlocking position.

FIG. 5 is a perspective view of the quick-release coupling according to the first embodiment of the invention in locking engagement with the matching counterpart, with the securing means being in the locking position.

FIG. 6 is a perspective view of the quick-release coupling according to a second embodiment of the invention, with the securing means being in the unlocking position.

FIG. 7 is a side view of the quick-release coupling according to FIG. 6.

FIG. 8 is another side view of the quick-release coupling according to FIG. 6.

FIG. 9 is a plan view of the quick-release coupling according to FIG. 6, wherein FIG. 9a shows a section along line A-A and FIG. 9b shows a section along line B-B.

FIG. 10 is a perspective exploded view of the quick-release coupling according to a third embodiment of the invention.

FIG. 11 is a perspective view of the quick-release coupling according to the third embodiment of the invention in a mounted condition.

### DETAILED DESCRIPTION OF THE PREFERRED EMBODIMENTS

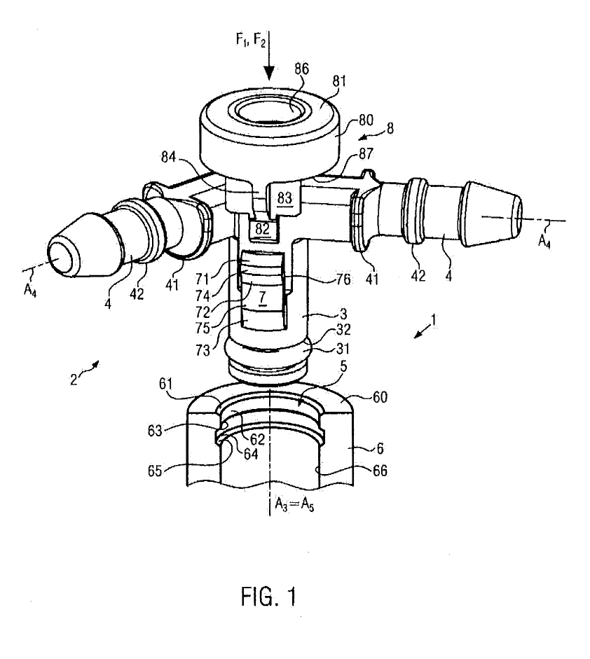

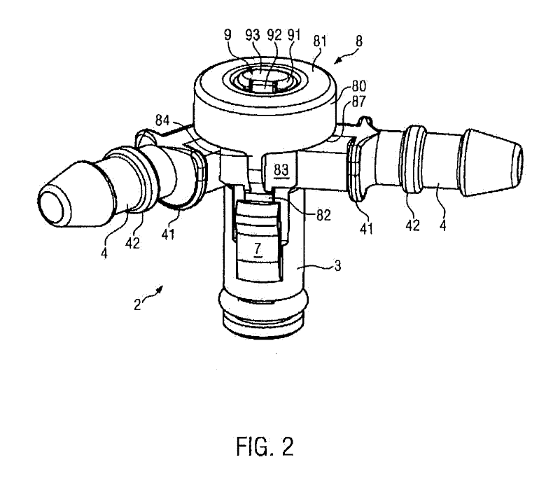

The first embodiment of the invention which will be described below with regard to FIGS. 1 to 5 relates to a quick-release coupling 1 for fluid pipes in the form of a leak-oil connector. FIG. 1 is a perspective view of the inventive quick-release coupling 1 according to the first embodiment with a counterpart 6 with a matching receiving opening 5, with the securing means 8 being in the unlocking position.

The inventive quick-release coupling 1 comprises an integrally formed, substantially T-shaped connector 2 of a glass-fiber reinforced plastic (e.g. PA66+6 GF30 or Polyamide 66+6 with a 30% glass-fiber portion) including a connecting piece 3 and two connecting pipes 4 radially protruding from said connecting piece 3. Any leak-oil pipes to be connected can be attached to the cone-shape end pieces of connecting pipes 4. The axes A4 of connecting pipes 4 extend radially to the axis A3 of connecting piece 3 and form an angle of about 135° with axis A3 of connecting piece 3. Axis A3 of connecting piece 3 coincides, when being in the inserted condition, with axis A5 of receiving opening 3 as intended. Holding portions 41, 42 provided at connecting pipes 4 may be used for positioning the connector 2 with regard to counterpart 6.

Connecting piece 3 can be inserted into receiving opening 5 of counterpart 6 in a sealing manner. In the insertion direction of quick-release coupling 1, a sealing ring 31 is held in a circumferential groove 32 at one end of connecting piece 3.

Receiving opening 5 defined in counterpart 6 comprises, starting from an upper surface 60 of counterpart 6, a chamfer 61 in the entrance region, a snap-in protrusion 62, a cone-shape widening 63, an undercut 64, a cone-shape tapering 65 and a holding area 66.

Two identically formed resilient latching or locking arms 7 protrude on diametrically opposed sides of the axis of connecting piece 3 in counter-insertion direction away from connecting piece 3 and can be brought into locking engagement with counterpart 6. Each of said locking arms 7 comprises a wedge face 71 substantially being formed at the free end of locking arm 7 adjacent to the largest radius of locking arm 7 and facing away from the direction of insertion of connecting piece 3. Wedge face 71 has an angle of about 45° to axis A3 of connecting piece 3. Further, each locking arm 7 is provided at its outside with two wedge faces 72, 73 facing away from connecting piece 3 in the direction of insertion, with wedge face 72 being formed adjacent to the greatest radius of locking arm 7, and wedge face 73 being formed directly adjacent to the cylindrical part of connecting piece 3. Wedge faces 72, 73 each comprise an angle of about 20° with regard to axis A3 of connecting piece 3. Due to the different angles of inclination of wedge faces 72, 73 with regard to axis A3 of connecting piece 3, an insertion force F2 of connecting piece 3 is smaller than a retraction force F4 of connecting piece 3. Glide surfaces 74 and 75 are provided between wedge faces 71, 72, 73 and extend substantially parallel to axis A3 of connecting piece 3, glide surface 74 defining the largest radius of locking arm 7. The outer contour of locking arm 7 has been adapted to the inner contour of receiving opening 5. Preferably, wedge faces 71, 72, 73 are substantially formed as cone envelope portions while glide surfaces 74, 75 are substantially formed as cylinder envelope portions. In inner side 76 of locking arm 7 facing towards connecting piece 3 is in the form of a wedge face and is continuously inclined from its low end up to the end of locking arm 7 with regard to the axis of connecting piece 3, preferably at an angle of about 10°.

Securing means 8 is preferably integrally formed of plastic or metal and overlaps connector 2 preferably on a side above connecting pipes 4 facing away in counter-insertion direction from connecting piece 3. To this end, securing means 8 comprises an annular and/or disc-shaped actuating element 80 comprising an actuating surface 81, 87 facing away from actuating element 80 in and against the direction of insertion of connecting piece 3, respectively, as well as two securing portions 82 extending on two opposing sides of connecting piece 3 in the insertion direction of connecting piece 3, respectively, and being provided at the end of a planar guide portion 83. Said guide portions 83 each comprise a web 84 centrally protruding radially outwards and extending parallel to axis A3 of the connecting piece. Guide portions 83 protrude from actuating portion 80 parallel to each other and parallel to the insertion direction of connecting piece 3. Two snap-in protrusions 85 are provided on opposing sides of the inner circumference 86 of the ring-shaped actuating element 80 and are radially protruding towards the inside. Securing means 8 can be fixed and caught positively to connector 2 in the unlocking and in the locking position via snap-in protrusions 85. Securing means 8 cooperates with connector 2 in such a manner that securing means 8 is provided at connector 2 in torsion-proof, gliding and captive manner and can be converted by being glided into or against the direction of insertion between the unlocking position in which the locking engagement of quick-release coupling 1 can be unlocked or released and the locking position in which the locking engagement can be guaranteed.

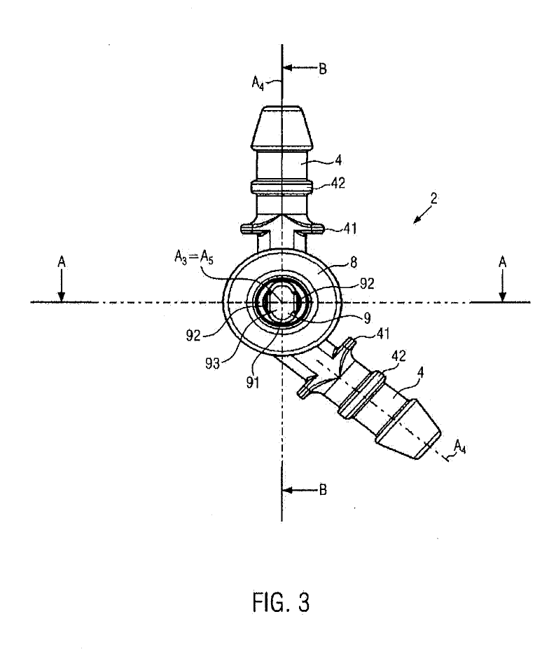

A fastening means 9 preferably formed as a molded part of plastic or metal is integrally connected or combined to connector 2 or is connected to the residual of connector 2 either in a fixed or in a releasable manner, in order to form a part of connector 2. Fastening means 9 comprises a substantially cylindrical fastening section 91 having two guiding webs 92 which extend on opposing sides of fastening section 91 parallel to axis A3 of the connecting piece. Snap-in projections 85 can movably be guided between the locking position and the unlocking position in said guiding webs 92 which are preferably arranged, with regard to axis A3, in an equiangular manner to locking arms 7 of connecting piece 3, or displaced by 90° to locking arms 7 (see FIGS. 3a, 3b). Each of said guiding webs 92 comprises two snap-in receptions 96, 97 limited by snap-in stages 94, 95 into which snap-in projections 85 can be fixed in a locking manner in the locking position and/or in the unlocking position. Additional snap-in receptions may be provided along guiding web 92.

The contours and the dimensions of connector 2, fastening means 9 and securing means 8 match to each other such that securing means 8 can be converted between unlocking and locking position in torsion-proof, tilt-proof and gliding manner. In particular, guide sections 83 have an inner contour matching to the outer contour of connector 2 and glide on the diametrically opposing outer sides of connector 2.

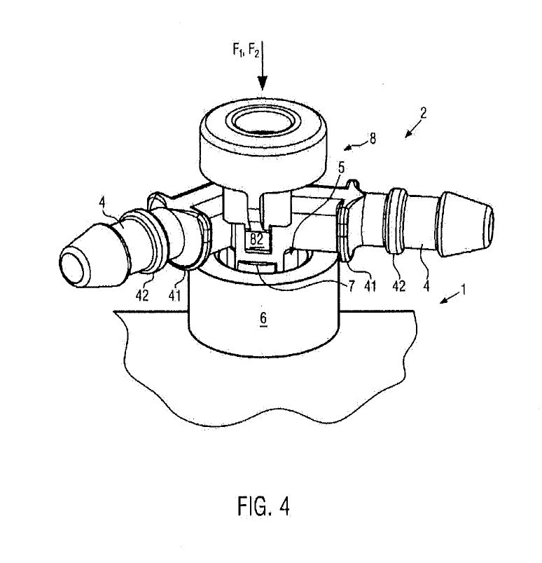

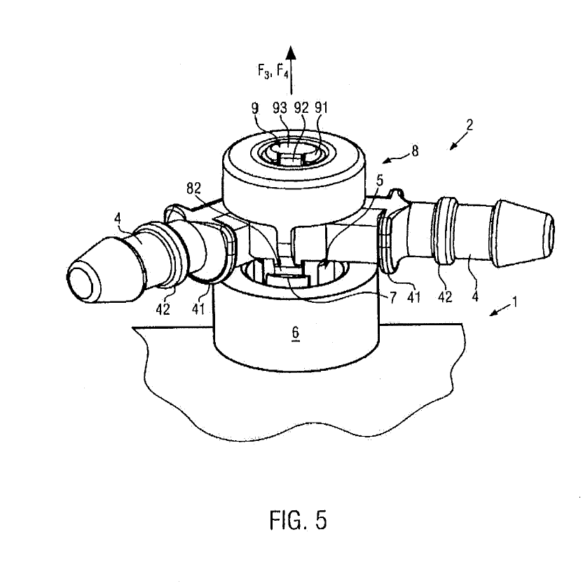

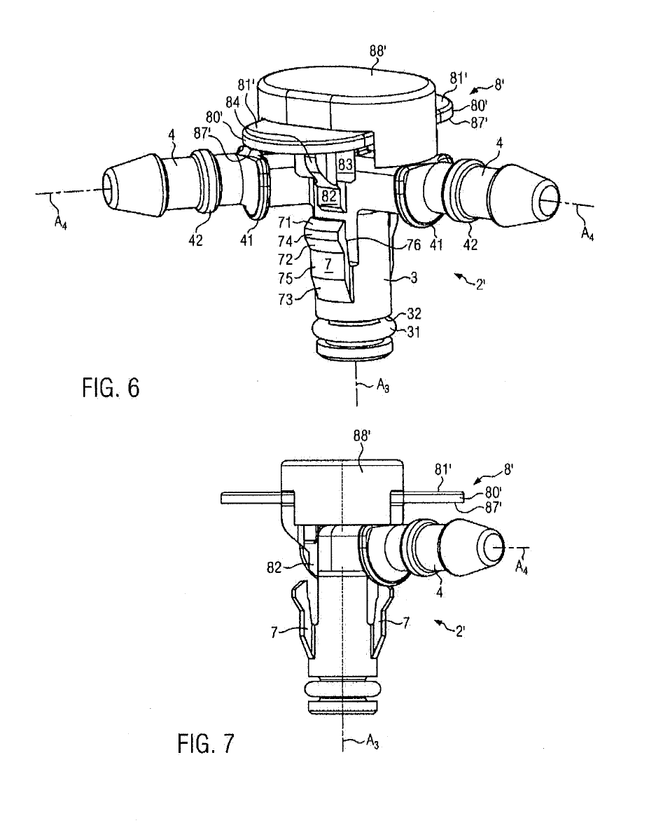

The second embodiment of the invention that will be described below with regard to FIGS. 6 to 9 is substantially based on the first embodiment of the invention. Identical features will be given identical reference numbers used in the first embodiment and it will be refrained from repeating the description. Those features differing from the first embodiment are given inverted commas and will be explained in the following.

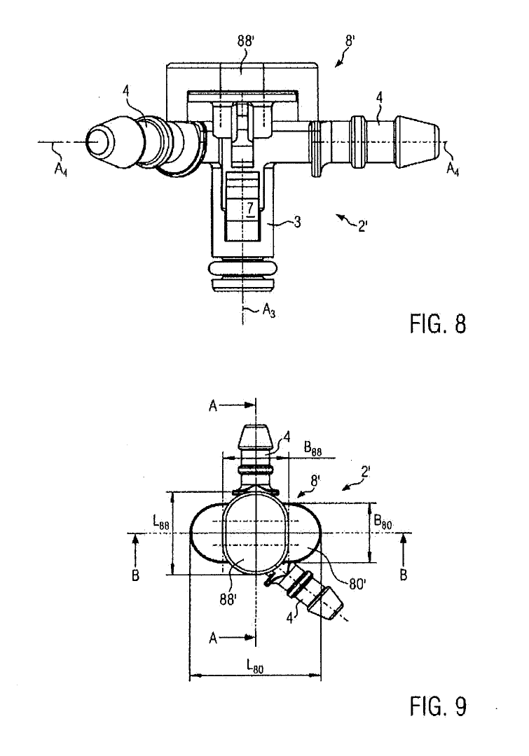

As a modification of the first embodiment, securing means 8′ comprises a differently formed, substantially annular and/or disc-shaped actuating element 80′ having a substantially oval contour, the ratio of length L80 (e.g. 20 mm) thereof to the width B80 (e.g. 10 mm) being approx. 2:1. Two actuating surfaces 81′, 87′ are respectively facing away from actuating element 80′ in or against the direction of insertion of connecting piece 3. Two securing portions 82 each extend in the insertion direction of connecting piece 3 and are positioned at the end of planar guide portions 83 on two opposing sides of connecting piece 3. Guide portions 83 each comprise a web 84 centrally protruding radially outwards. Actuating element 80′ is arranged on a side facing away from connector 2′ in counter-insertion direction of connecting piece 3 and is fixed in a captive manner to connector 2′ by means of a lid 88′ that can be mounted to connector 2′ and is of a substantially oval contour of a ratio of length L88 to width B88 of approx. 1.4:1. To this end, lid 88′ serves as a securing element for positively fixing or securing actuating element 80′ with regard to connector 2′. Length L88 of lid 88′ (e.g. 14 mm) preferably extends parallel to an axis A4 and/or transverse to length L80 and/or parallel to width B80 of actuating element 80′ and is larger than width B80 of actuating element 80′ by preferably approx. 40%. Lid 88′ has been inserted into a corresponding reception of fastening means 9′ by means of a pin protruding in the direction of insertion and penetrating actuating element 80′ so as to secure same to connector 2′ in a captive manner (FIG. 9a). Two lateral supporting arms of inserted lid 88′ reach down to the level of connecting pipes 4 and overlap actuating element 80′ at the margin-side towards width B80 thereof (FIG. 9; FIG. 9a). The diameter D88 of the pin is for example approx. 1.5 mm. The inner circumference of the annular actuating element 80′ is provided with two radially inwards projecting snap-in protrusions 85′ by which securing means 8′ can be positively fixed and latched to connector 2′ either in the unlocking or in the locking position. Securing means 8′ cooperates with connector 2′ in such a manner that securing means 8′ is mounted to connector 2′ in torsion-proof, movable and captive manner and can be converted by being moved in or against the direction of insertion between the unlocking position in which the locking engagement of quick-release coupling 1 can be unlocked and the locking position in which the locking engagement is secured.

Fastening means 9′ comprises a substantially hollow-cylindrical fastening portion 91′ with two guiding webs extending on opposing sides of fastening portion 91′ parallel to axis A3 of connecting piece 3. Snap-in projections 85′ can movably be guided in said guiding webs between the locking and the unlocking position. The guiding webs each comprise an upper snap-in reception 96′ which is limited by snap-in stage 95′ and lid 88′, and a lower snap-in reception 97′ below snap-in stage 95′. The pin of lid 88′ has been inserted into hollow-cylindrical fastening portion 91′ so that lid 88′ limits the guiding webs to the top and forms the upper stop of the guiding webs. Snap-in protrusions 85′ can be fixed in a locking manner in said snap-in receptions 96′, 97′ in the locking and/or unlocking position. Additional snap-in receptions may be provided along the guiding webs.

As in the first embodiment, the contours and the dimensions of connector 2′, fastening means 9′ and securing means 8′ match to each other such that securing means 8′ can be converted between unlocking and locking position in torsion-proof, tilt-proof and gliding manner. In particular, guide sections 83 have an inner contour matching to the outer contour of connector 2′ and glide on the diametrically opposing outer sides of connector 2′.

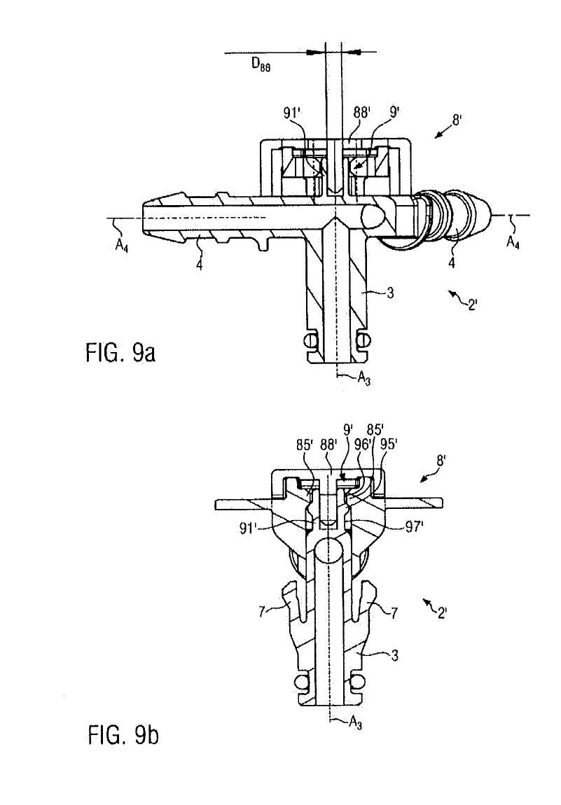

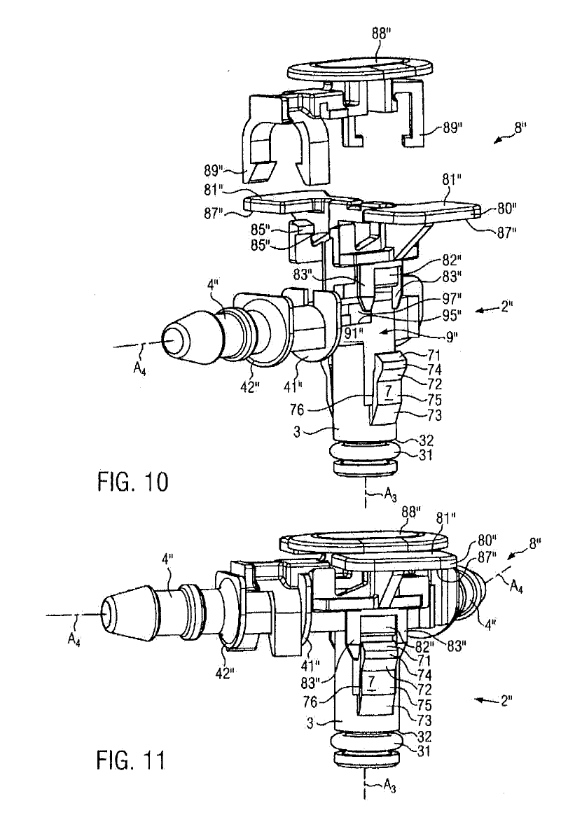

The third embodiment of the invention that will be described below with regard to FIGS. 10 and 11 is substantially based on the first and second embodiments of the invention. Identical features will be given identical reference numbers used in the first or second embodiment and it will be refrained from repeating the description. Those features differing from the first or second embodiment are given two inverted commas and will be explained in the following.

As a modification of the first or second embodiment, securing means 8″ comprises another differently formed, substantially seesaw-shaped actuating element 80″ having two substantially rectangular actuating surfaces 81″, 87″ are respectively facing away from actuating element 80″ in or against the direction of insertion of connecting piece 3. Two securing portions 82″ each extend in the insertion direction of connecting piece 3 on two opposing sides of connecting piece 3. Securing portions 82″ each are laterally bordered or limited by two guide portions 83″ projecting further away from actuating element 80″ in the direction of insertion of connecting piece 3 than securing portions 82″ themselves and also projecting in radial direction beyond securing portions 82″. To this end, securing means 8″ is of an inner contour that is adapted to the outer contours of locking arms 7 so that securing means 8″ is guided in a gliding manner at locking arms 7 between the unlocking and the locking position in torsion-proof and/or tilt-proof manner. Guide portions 83″ laterally glide along locking arms 7 and prevent tilting or torsion of securing means 8″ with regard to locking arms 7 and with regard to connector 2″. The outer contour of said guide portions 83″ matches to the inner contour of the reception opening of a counterpart so as to allow guide portions 83″ to be supported on said counterpart and to center connector 2″ in said reception opening when in the inserted condition. It may turn out to be useful to have the reception opening being closed, at least section-wise, by said guide portions 83″ when securing means 8″ is in the locking position. Actuating element 80″ is arranged on a side facing away from connector 2″ in counter-insertion direction of connecting piece 3 and is secured to connector 2″ by means of a lid 88″ that can be mounted to connecting pipes 4″ of connector 2″ in a captive manner. Lid 88″ substantially extends in a bridge-shaped form transverse to the longitudinal extension of actuating element 80″ and can positively snap on connecting pipes 4″ of connector 2″ between holding portions 41″, 42″ via locking portions 89″. Snap-in protrusions 85″ provided at opposite inner sides of actuating element 80″ and projecting inwards and serve to positively fix and lock securing means 8″ to connector 2″ when in the unlocking and locking position. Securing means 8″ cooperates with connector 2″ in such a manner that securing means 8″ is mounted to connector 2″ in torsion-proof, movable and captive manner and can be converted by movement in or against the direction of insertion between the unlocking position in which the locking engagement of quick-release coupling 1 can be unlocked and the locking position in which the locking engagement is secured.

Fastening means 9″ comprises a fastening portion 91″ with at least one snap-in reception 97″ limited by snap-in stage 95″ and lid 88″. When in unlocking position, snap-in protrusions 85″ can be fixed and caught directly to lid 88″ (FIG. 11) and, when in locked position, in snap-in reception 97″.

As in the first and second embodiments, the contours and the dimensions of connector 2″, fastening means 9″ and securing means 8″ match to each other such that securing means 8″ can be converted between unlocking and locking position in torsion-proof, tilt-proof and gliding manner. In particular, guide sections 83″ have an inner contour matching to the outer contour of connector 2″ and glide on the diametrically opposing outer sides of connector 2″.

The preferred application of the invention will be explained below in detail with regard to the first embodiment according to FIGS. 1 to 5. The preferred applications of the second and third embodiments largely correspond to the preferred application of the first embodiment and will not be described separately.

Quick-release coupling 1 according to the invention is inserted in the direction of insertion into receiving opening 5 of counterpart 6, while securing means 8 is preferably caught in the unlocking position at fastening means 9. In the unlocking position (FIG. 1), snap-in protrusions 85 are positioned in the first snap-in reception 96 between snap-in stages 94, 95 (FIG. 3b). To this end, securing portions 82 are not in engagement with locking arms 7 (FIG. 3a) so that locking arms 7 can be radially urged towards the inside.

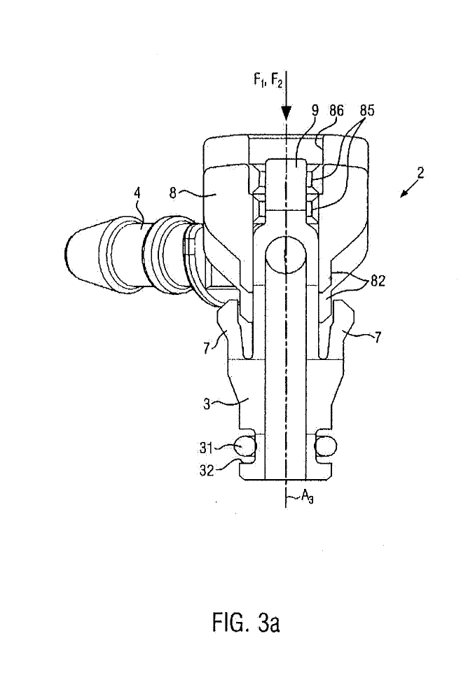

During the insertion of connecting piece 3 into counterpart 6, connecting piece 3 is first centered in receiving opening 5 by means of wedge faces 72, 73 facing away from connecting piece 3. Without any force being applied in the direction of insertion, wedge faces 72 facing away from connecting piece 3 in the direction of insertion lie flat against snap-in protrusion 62. Applying an insertion force F2 causes interaction of locking arms 7 with snap-in protrusion 62 via wedge engagements so that locking arms 7 are radially urged towards the inside, in order to glide with glide surface 75 over snap-in protrusion 62. Owing to the resilient properties of locking arms 7, same return to a position projecting away from connecting piece 3 so that locking arms 7 find their way into undercut 64 behind snap-in protrusion 62 where they are caught or locked in place. Wedge faces 71 facing away from connecting piece 3 in counter-insertion direction get into engagement with snap-in protrusion 62 and widening 63, with locking arms 7 being entirely accommodated in receiving opening 5 and not projecting from receiving opening 5 over surface 60 of counterpart 6. Thus, quick-release coupling 1 is in locking engagement with counterpart 6, as shown in FIG. 4.

Securing means 8 is now converted by means of displacement or movement with regard to fastening means 9 in the direction of insertion from the unlocking to the locking position. According to the invention, converting securing means 8 from the unlocking position to the locking position requires a latching force F1 preferably acting in the direction of insertion to securing means 8 which is larger than insertion force F2 preferably acting in the direction of insertion to securing means 8, in order to bring connecting piece 3 into latching engagement with counterpart 6. In the present case this will be done in that the force F1 which has to be applied to securing means 8 in the direction of insertion to bring snap-in protrusions 85 from the first snap-in reception 96 between snap-in stages 94, 95 to the second snap-in reception 97 below snap-in stage 95 (FIG. 3b) has been set to be larger, due to design features, than the force F2 which has to be applied to securing means 8 in the direction of insertion, in order to urge locking arms 7 radially towards the inside until same glide together with glide surface 75 over snap-in protrusion 62 and latch behind snap-in protrusion 62. Latching force F1 can be determined, e.g. by selecting the length and/or the angle of inclination of the meshing flanks of snap-in protrusions 85 and of snap-in stages 94, 95 with regard to axis A3 of connecting piece 3. Due to the fact that latching force F1 has been set to be larger than insertion force F2, it can be made sure that connecting piece 3 is in latching engagement with counterpart 6 in any case when securing means 8 is being converted from the unlocking position to the locking position during the insertion.

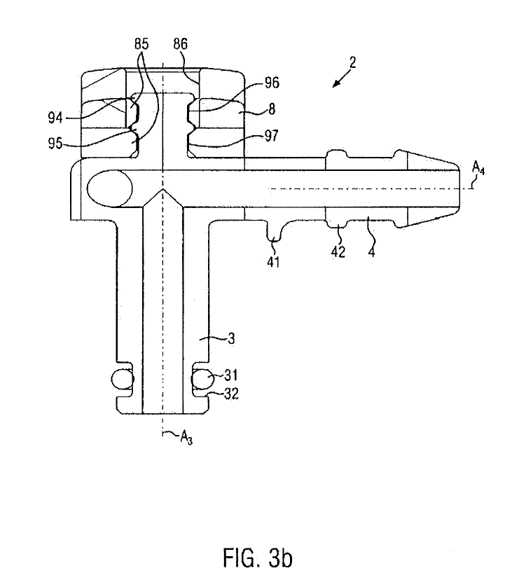

When in the locking position (FIG. 5), securing portions 82 cooperate with locking arms 7 in such a manner that locking arms 7 cannot be urged in radial direction towards the inside (see FIG. 3a). Rather are locking arms 7 spread apart from connecting piece 3 and urged deeper into receiving opening 5 by means of web engagement with snap-in protrusion 62. Thus, there is a secondary securing or locking. Accordingly, connecting piece 3, when in the locking position, cannot be withdrawn or retracted from receiving opening 5. When in the locking position, snap-in protrusions 85 are positioned in the second snap-in reception 97 below snap-in stage 95 (FIG. 3b), and actuating surface 81 facing away from connecting piece 3 substantially lines up precisely with the upper side 93 of fastening means 9 facing away from connecting piece 3 (FIG. 5) so that actuating surface 81 and upper side 93 of fastening means 9 lie in one plane.

By applying an unlocking force F3 in the counter-insertion direction (FIG. 5), preferably to the actuating surface 87 facing away from actuating element 80 in the insertion direction, securing means 8 can already be converted from the locking position to the unlocking position. In the unlocking position, securing means 8 is not in engagement with locking arms 7 so that locking arms 7 can be urged radially towards the inside. By applying retraction force F4 in counter-insertion direction, quick-release coupling 1 can be retracted from receiving opening 5.

Preferably, the forces behave as follows: |F3|≧|F4|>|F1|>|F2| or |F4|≧|F3|>|F1|>|F2|. The latching force F1 preferably is at least 30 N, preferably 30 to 50 N, particularly preferably 40N. In case of a manual handling/mounting, the actuating force should not exceed 30 N. As mounting of the quick-release coupling according to the invention is preferably done in an automated manner, the standard value of 30 N can be exceeded intentionally.

When in the unlocking position, securing means 8 is again fixed or locked to fastening means 9, with snap-in protrusions 85 being positioned in the first snap-in reception 96 between snap-in stages 94, 95. Accordingly, securing means 8 can reversibly be converted between the locking and the unlocking positions.

Owing to the special design of securing means 8, 8′, 8″ and of actuating element 80, 80′, 80″, the inventive quick-release coupling is particularly suitable for automated solutions, as actuating element 80, 80′, 80″ can especially easily be taken and positioned by means of a gripper arm of a mounting apparatus. Due to the contours and dimensions matching to each other, securing means 8, 8′, 8″ can be held to connector 2, 2′, 2″ in a torsion-proof, tilt-proof and captive manner and can be movably converted between unlocking and locking positions.

The quick-release coupling is not restricted to the described embodiments. Any modifications within the frame of the wording of the claims are conceivable.

1. A quick-release-coupling for fluid pipes, comprising:
a connector with a connecting piece and at least one connecting pipe transversely projecting from said connecting piece, the connecting piece being configured for insertion into a receiving opening of a counterpart in a sealing manner and brought into locking engagement with said counterpart of a locking means; and
a securing means for conversion from a locking position in which the locking engagement is secured against unlocking to an unlocking position in which the locking engagement can be disengaged, wherein a force for converting the securing means from the unlocking position to the locking position is larger than a force for bringing the connecting piece into locking engagement with the counterpart.

2. The quick-release coupling according to claim 1, wherein the securing means is arranged, at least section-wise, on a side facing away from the connector in a counter-insertion direction of the connecting piece.

3. The quick-release coupling according to claim 1, wherein the securing means comprises:
an actuating element which is arranged on a side facing away from the connector in a counter-insertion direction of the connecting piece.

4. The quick-release coupling according to claim 3, wherein the actuating element is of substantially annular shape.

5. The quick-release coupling according to claim 3, wherein the actuating element comprises:
at least one actuating surface facing away from the actuating element in a counter-insertion direction of the connecting piece; and/or
at least one actuating surface facing away from the actuating element in insertion direction of the connecting piece.

6. The quick-release coupling according to claim 3, wherein the actuating element comprises:
an opening extending in a counter-insertion direction of the connecting piece in or through the actuating element.

7. The quick-release coupling according to claim 6, wherein at least a part of the connector is configured be received in the opening of the actuating element.

8. The quick-release coupling according to claim 3, wherein at least a part of the connector, lines up precisely with at least a part of the actuating element in at least one position of the securing means.

9. The quick-release coupling according to claim 1, wherein the securing means comprises:
an inner contour matching to an outer contour of a part of the connector so that the securing means will be movably guided with regard to the connector between the unlocking position and the locking position in a torsion-proof and/or tilt-proof manner.

10. The quick-release coupling according to claim 1, wherein the securing means and/or the connector comprise:
at least one snap-in protrusion;
at least one guiding web; and
at least one snap-in reception provided within the guiding web, the snap-in protrusion being configured to be movably guided in the guiding web between the locking and the unlocking position, and the snap-in protrusion being configured to snap into the snap-in reception when in the locking and/or the unlocking position.

11. A quick-release coupling for fluid pipes, comprising:
a connector with a connecting piece and at least one connecting pipe transversely projecting from said connecting piece, the connecting piece being configured for insertion into a receiving opening of a counterpart in a sealing manner and brought into locking engagement with said counterpart by a locking means; and
a securing means for conversion from a locking position in which the locking engagement is secured against unlocking to an unlocking position in which the locking engagement can be disengaged, the locking means comprising at least one locking arm, wherein the securing means and the locking arm have contours matching to each other so that the securing means will be movably guided at the locking arm between the unlocking position and the locking position.

12. The quick-release coupling according to claim 2, wherein the securing means comprises:
an actuating element which is arranged on a side facing away from the connector in a counter-insertion direction of the connecting piece.

13. The quick-release coupling according to claim 12, wherein the actuating element is of substantially annular shape.

14. The quick-release coupling according to claim 2, wherein the actuating element comprises:
at least one actuating surface facing away from the actuating element in a counter-insertion direction of the connecting piece; and
at least one actuating surface facing away from the actuating element in insertion direction of the connecting piece.

15. The quick-release coupling according to claim 14, wherein the actuating element comprises:
at least one actuating surface facing away from the actuating element in a counter-insertion direction of the connecting piece; and
at least one actuating surface facing away from the actuating element in insertion direction of the connecting piece.

16. The quick-release coupling according to claim 15, wherein the actuating element comprises:
an opening extending in a counter-insertion direction of the connecting piece in or through the actuating element.

17. The quick-release coupling according to claim 16, wherein at least a part of the connector is configured be received in the opening of the actuating element.

18. The quick-release coupling according claim 17, wherein at least a part of the connector, lines up precisely with at least a part of the actuating element in at least one position of the securing means.

19. The quick-release coupling according to claim 18, wherein the securing means comprises:
an inner contour matching to an outer contour of a part of the connector so that the securing means will be movably guided with regard to the connector between the unlocking position and the locking position in a torsion-proof and/or tilt-proof manner.

20. The quick-release coupling according to claim 19, wherein the securing means and/or the connector comprise:
at least one snap-in protrusion;
at least one guiding web; and
at least one snap-in reception provided within the guiding web, the snap-in protrusion being configured to be movably guided in the guiding web between the locking and the unlocking position, and the snap-in protrusion being configured to snap into the snap-in reception when in the locking and/or the unlocking position.
